(19) United States
(12) Patent Application Publication
(10) Pub. No.: US 2015/0324613 A1
(43) Pub. Date: Nov. 12, 2015

(54) METHOD AND APPARATUS FOR PROTECTING BINARY DATA IN NON-VOLATILE MEMORY

(71) Applicant: ABOV SEMICONDUCTOR CO., LTD., Cheongwon-Gun (KR)

(72) Inventors: Dae Jin Park, Gumi (KR); Kwang Hee Lee, Bucheon (KR)

(73) Assignee: ABOV SEMICONDUCTOR CO., LTD.

(21) Appl. No.: 14/802,620

(22) Filed: Jul. 17, 2015

Related U.S. Application Data
(63) Continuation of application No. PCT/KR2013/011504, filed on Dec. 12, 2013.

(30) Foreign Application Priority Data
Jan. 18, 2013 (KR) 10-2013-0005978

(51) Int. Cl. G06F 21/78; G06F 12/14

(52) U.S. Cl. CPC G06F 21/78; G06F 12/1408; G06F 2212/402

(57) ABSTRACT

A method and an apparatus of protecting binary data stored in non-volatile memory are disclosed herein. The apparatus for protecting binary data in non-volatile memory includes a reception unit, a detection unit, a generation unit, an encryption unit, and a storage unit. The reception unit receives program code. The detection unit detects the binary pattern of binary data constituting the program code by analyzing the received program code. The generation unit generates unique pattern information corresponding to the binary pattern based on the detected binary pattern. The encryption unit encrypts the program code using the generated unique pattern information as a key value. The storage unit stores the encrypted program code in memory.

### CROSS-REFERENCE TO RELATED APPLICATION

This application is a continuation of PCT/KR2013/011504 filed on Dec. 12, 2013, which claims priority to Korean Application No. 10-2013-0005978 filed on Jan. 18, 2013, which application is incorporated herein by reference.

### TECHNICAL FIELD

The present invention relates to the protection of binary data in non-volatile memory and, more particularly, to a method and apparatus for protecting binary data in non-volatile memory with encryption and decryption of the binary data.

### BACKGROUND ART

Flash memory is non-volatile, which means that information is stored in a semiconductor in such a manner that the flash memory does not require power to maintain information about a chip. Flash memory stores information in an array of transistors called “cells,” each storing one- or more-bit information. Each memory cell is based on a floating-gate avalanche-injection metal oxide semiconductor (FAMOS) transistor. An FAMOS transistor is intrinsically a complementary metal oxide semiconductor (CMOS) field effect transistor (FET) having a suspended additional conductor between its gate terminal and source/drain terminals. Current flash memory devices have two basic array architectures. Names denoting the types of NOR flash and NAND flash logic are used in a storage cell array.

A flash cell is similar to a standard MOSFET transistor except that it includes two gates instead of a single gate. One of the two gates is the same as a control gate (CG) in other MOS transistors, and the other is a floating gate (FG) fully insulated by an oxide layer. The FG is insulated by the oxide layer, so that specific electrons placed on the FG are trapped by the FG, with the result that the FG stores information.

When the electrons are trapped on the FG, they modify (partially offset) an electric field from the CG. This modifies the threshold voltage Vt of the cell. Accordingly, when the cell is “read” by making the CG have a specific voltage, an electric current may or may not flow between the source and drain connections of the cell depending on the Vt of the cell. The presence or absence of such an electric current is detected, the Vt may switch to ‘1’ or ‘0,’ and thus data stored as described is played back.

Non-volatile memory, such as the aforementioned flash memory, stores a program unique to a manufacturer, and uses the program for the purpose of specific control. In order to prevent the illegitimate leakage of such a program, a password is used. If the password is not known, an accurate program cannot not be used.

The read protection circuit of conventional non-volatile memory has prevented other people from illegitimately using the program content of the non-volatile memory by performing an exclusive NOR (XNOR) combination of the data of an encryption unit having a specific program and the data of a non-volatile memory cell unit. If the number of cells of the non-volatile memory cell unit that have not been programmed is larger than the number of cells of the encryption unit, however, the value of the XNOR combination of the data of the non-volatile memory cell unit that has not been programmed and the data of the encryption unit becomes the same as the data of the encryption unit. Accordingly, a problem arises in that a program stored in non-volatile memory is illegitimately leaked because the data of the encryption unit is easily exposed to other people.

Therefore, there is a need for a configuration that is capable of preventing the illegitimate leakage of a program stored in non-volatile memory. Korean Patent No. 10-0258861 entitled “Read prevention circuit for ROM” suggests a technology that was developed in order to prevent the illegitimate leakage of a program stored in non-volatile memory.

The conventional art relates to a read prevention circuit for non-volatile memory in which an applied address signal and the actual address of a memory cell are differently modified in response to a scramble weight bit so that other people cannot read the program stored in non-volatile memory. The conventional art is adapted to prevent the illegitimate leakage of a program by preventing the exposure of a password.

That is, the conventional art is adapted to prevent the exposure of a password. In the conventional art, if the same program is encrypted in non-volatile memory, there is a possibility that an encryption algorithm and a password may be derived by repeatedly analyzing an encrypted pattern because all encrypted and stored data is the same. As a result, there is a need for a configuration that is capable of preventing the leakage of a program by encrypting the same program using a different encryption key when the same program is encrypted.

### SUMMARY OF THE DISCLOSURE

The present invention has been made to solve the above problems occurring in the conventional art, and an object of the present invention is to provide a method and apparatus for protecting binary data in non-volatile memory, which encrypt the same program code using the binary pattern of the program code, unique information related to non-volatile memory, user information, and time or date information when the same program code is stored in the non-volatile memory, thereby improving the protection level of the binary data stored in the non-volatile memory.

Furthermore, an object of the present invention is to provide a method and apparatus for protecting binary data in non-volatile memory, which differently encrypt and store program code for each piece of non-volatile memory, thereby adaptively encrypting the program code for each piece of non-volatile memory even without using complicated encryption hardware.

In accordance with an aspect of the present invention, there is provided a method of protecting binary data in non-volatile memory, including receiving program code; detecting the binary pattern of binary data constituting the program code by analyzing the received program code; generating unique pattern information corresponding to the binary pattern based on the detected binary pattern; encrypting the program code using the generated unique pattern information; and storing the encrypted program code in memory.

The encrypting may include encrypting the program code by further taking into account at least one of the unique manufacturing information and unique chip information of the memory, and may include encrypting the program code by further taking into account at least one of user information and time or date information.

The method may further include decrypting the encrypted program code stored in the memory using the unique pattern information; and reading the decrypted program code.

The method may further include storing the generated unique pattern information in a predetermined storage region, and the decrypting may include decrypting the encrypted program code using the stored unique pattern information.

The method may further include segmenting the data region of the received program code into a plurality of regions, the detecting may include detecting the data pattern of the data of each of the plurality of segmented regions, the generating may include generating the unique data pattern information of the data of each of the plurality of regions based on the detected data pattern, and the encrypting may include encrypting the data of each of the plurality of regions using the generated unique data pattern information.

The method may further include segmenting the data region of the received program code into a plurality of regions, and the detecting may include detecting the data pattern of the data of each of the plurality of segmented regions and detecting the binary pattern using the detected data patterns.

In accordance with another aspect of the present invention, there is provided an apparatus for protecting binary data in non-volatile memory, including a processor, which includes a reception unit configured to receive program code; a detection unit configured to detect the binary pattern of binary data constituting the program code by analyzing the received program code; a generation unit configured to generate unique pattern information corresponding to the binary pattern based on the detected binary pattern; an encryption unit configured to encrypt the program code using the generated unique pattern information as a key value; and a storage unit configured to store the encrypted program code in memory.

In accordance with the present invention, the protection level of binary data stored in non-volatile memory can be improved by adaptively encrypting and storing the same program code when the same program code is stored in each piece of non-volatile memory.

More specifically, the present invention can improve the protection level of binary data stored in non-volatile memory because program code to be stored is encrypted using the binary pattern of the program code, unique information related to the non-volatile memory, user information, and time or date information and then the encrypted program code is stored in the non-volatile memory.

Furthermore, the present invention can improve the protection level of program code stored in non-volatile memory because differently encrypted program code can be stored in each piece of non-volatile memory even without using complicated encryption hardware, and can improve competitiveness because the unit price of a device is lowered.

### BRIEF DESCRIPTION OF THE DRAWINGS

FIG. 1 illustrates the configuration of an apparatus for protecting binary data in non-volatile memory according to an embodiment of the present invention;

FIG. 2 illustrates the configuration of the detection unit of FIG. 1 according to an embodiment of the present invention;

FIG. 3 illustrates an operation flowchart of a method of protecting binary data in non-volatile memory according to an embodiment of the present invention;

FIG. 4 illustrates an operation flowchart of step S360 of FIG. 3 according to an embodiment of the present invention;

FIG. 5 illustrates an operation flowchart of step S360 of FIG. 3 according to another embodiment of the present invention;

FIG. 6 illustrates an operation flowchart of step S330 of FIG. 3 according to an embodiment of the present invention;

FIG. 7 illustrates an operation flowchart of a method of reading the stored program code of FIG. 3 according to an embodiment of the present invention;

FIG. 8 illustrates an example of a process of generating unique pattern information from the binary data of program code; and

FIG. 9 illustrates an example of a process of encrypting the binary data of program code.

### DETAILED DESCRIPTION OF THE DISCLOSURE

The terms used herein are used merely to describe specific embodiments, but are not intended to limit the present invention. The singular expressions used herein include plural expressions unless explicitly stated otherwise in the context thereof. It should be appreciated that in this application, the use of the terms “include(s),” “comprise(s)”, “including” and “comprising” is intended to denote the presence of the characteristics, numbers, steps, operations, elements, or components described herein, or combinations thereof, but is not intended to exclude the probability of presence or addition of one or more other characteristics, numbers, steps, operations, elements, components, or combinations thereof.

Unless defined otherwise, all terms used herein, including technical terms or scientific terms, have the same meanings as those generally understood by persons of ordinary skill in the technical field to which the present invention pertains. The terms, such as terms that are generally used and defined in dictionaries, should be construed as having meanings identical to those that are used in the context of related technology, and should not be construed as having ideal or excessively formal meanings unless explicitly defined otherwise.

Preferred embodiments of the present invention will be described in detail with reference to the accompanying drawings. In the following description of the present invention, if it is determined that detailed descriptions of related well-known configurations or functions may make the gist of the present invention obvious, the detailed descriptions will be omitted.

However, the present invention is not restricted or limited to the embodiments. The same reference symbols represented throughout the drawings designate the same elements.

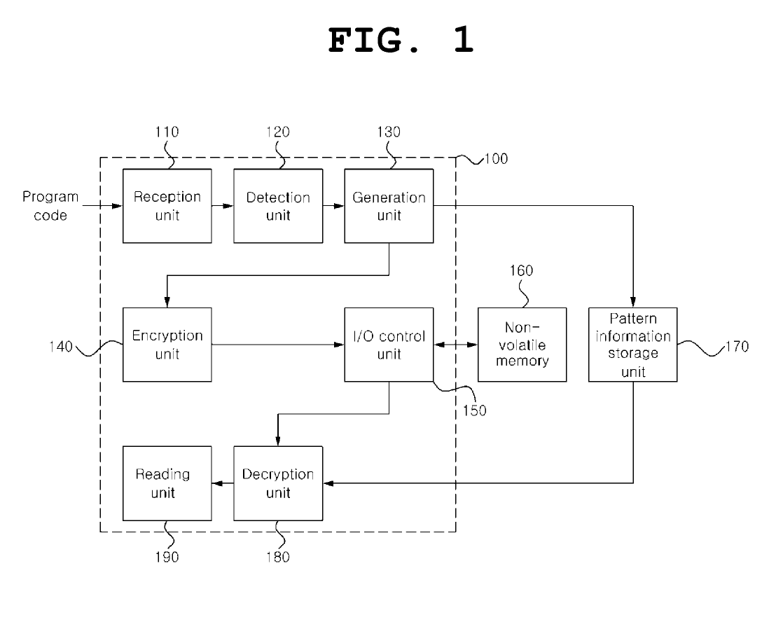

Hereinafter, a method and apparatus for protecting binary data in non-volatile memory according to an embodiment of the present invention are described in detail with reference to FIGS. 1 to 9.

FIG. 1 illustrates the configuration of an apparatus for protecting binary data in non-volatile memory according to an embodiment of the present invention.

Referring to FIG. 1, the apparatus according to the present embodiment includes a processor 100. The processor 100 includes a reception unit 110, a detection unit 120, a generation unit 130, an encryption unit 140, an I/O control unit 150, a decryption unit 180, and a reading unit 190. The apparatus according to the present embodiment further includes non-volatile memory 160, and a pattern information storage unit 170.

The reception unit 110 receives program code to be stored in the non-volatile memory 160 from the outside.

In this case, the reception unit 110 may receive the program code via a device which is capable of generating the program code or an external storage means in which a program or program code has been stored.

The detection unit 120 detects the binary pattern of binary data constituting the program code by analyzing the program code received by the reception unit 110.

In this case, the detection unit 120 may detect the binary pattern based on the pattern of the bit value ‘1’ of the program code, or may detect the binary pattern based on the pattern of the bit value ‘0.’

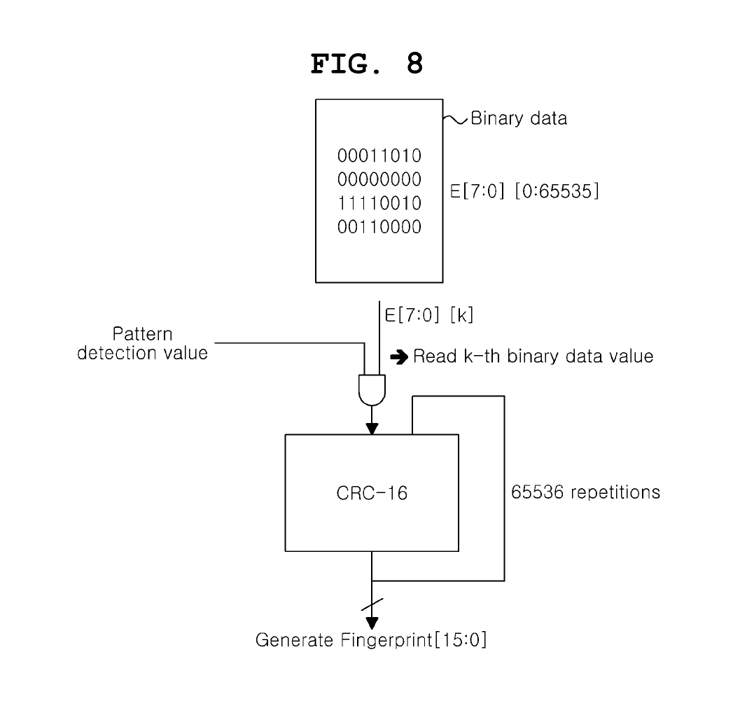

For example, as illustrated in FIG. 8, the detection unit may combine the k-th 8-bit binary data E[7:0][k] of 64 KB binary data E[7:0][0:65535] and a predetermined pattern detection value, and may detect the binary pattern of the 64 KB binary data through repeated execution for 64 KB.

Furthermore, the detection unit 120 may divide the binary data region of the program code into a plurality of regions, may detect the data pattern of each of the segmented data regions, and may detect the binary pattern using the data pattern of each of the plurality of detected data regions.

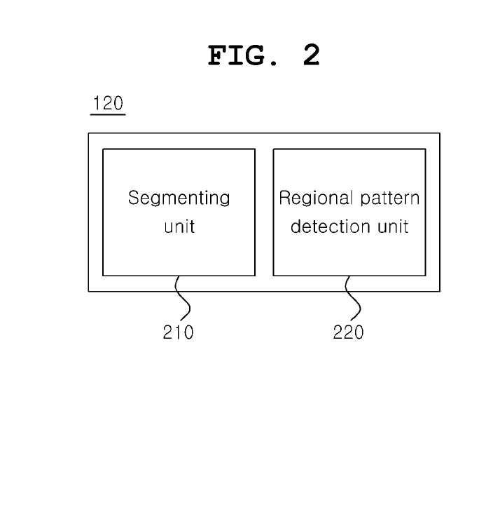

The segmenting into a plurality of regions and the detection of a plurality of data patterns are described with reference to FIG. 2.

FIG. 2 illustrates the configuration of the detection unit of FIG. 1 according to an embodiment of the present invention.

Referring to FIG. 2, the detection unit 120 includes a segmenting unit 210 and a regional pattern detection unit 220.

The segmenting unit 210 segments the data region of program code, that is, the data region of binary data, into a plurality of regions.

In this case, the segmenting unit 210 may divide and assign the binary data into a predetermined number of data regions, or may divide and assign the binary data of the program code based on a predetermined region.

The regional pattern detection unit 220 detects the data pattern of each of the plurality of data regions obtained by the segmenting unit 210.

That is, the regional pattern detection unit 220 detects the plurality of data patterns of the plurality of data regions of the program code.

In this case, the regional pattern detection unit 220 may detect the data pattern of a corresponding data region by taking into account the patterns of neighbor data regions.

As illustrated in FIG. 8, the regional pattern detection unit 220 may detect the data pattern of each of the plurality of data regions using a predetermined pattern detection value.

Referring back to FIG. 1, the generation unit 130 generates unique pattern information corresponding to the binary pattern based on the binary pattern detected by the detection unit 120.

In this case, the generation unit 130 may generate unique pattern information corresponding to the binary pattern detected by the detection unit 120 using a data table in which the unique pattern information corresponding to information about the binary pattern has been previously stored, or may generate the unique pattern information corresponding to the binary pattern using a predetermined function using the information about the binary pattern as a variable.

For example, the generation unit 130 may generate the unique pattern information using secure hash algorithm (SHA)-1, or may generate 16-bit unique pattern information Fingerprint[15:0] corresponding to the pattern of the binary data using cyclic redundancy check (CRC)-16 having the unique pattern information of the binary data as an input, as illustrated in FIG. 8. That is, the unique pattern information generated by the generation unit is information uniquely generated based on the binary data of the program code, and may have 8-bit, 16-bit or 32-bit information depending on a method of generating the unique pattern information. As in the example illustrated in FIG. 8, the unique pattern information may be generated through repeated execution corresponding to the number of bytes of the program code (wherein 64 K=65536 times).

It will be apparent that if the data patterns of a plurality of data regions are detected by the detection unit 120, the generation unit 130 may generate a plurality of pieces of unique data pattern information corresponding to the plurality of data patterns, respectively.

In this case, the generation unit 130 may generate the unique pattern information of the program code using the plurality of pieces of unique data pattern information.

The pattern information storage unit 170 stores the unique pattern information or the unique data pattern information of each of the data regions generated by the generation unit 130.

In this case, the information stored in the pattern information storage unit 170 is used for the decryption unit 180 to decrypt data stored in the non-volatile memory 160, that is, encrypted program code.

The pattern information storage unit 170 may store the unique pattern information or the unique data pattern information in some region of the non-volatile memory 160, or may store the unique pattern information or the unique data pattern information in a storage means that is separately provided.

The encryption unit 140 is a component that encrypts the binary data of the program code using the unique pattern information generated by the generation unit 130. An algorithm used for the encryption may be a predetermined encryption algorithm, or may be an encryption algorithm that is randomly selected from a plurality of algorithms. That is, the encryption unit 140 may generate an encryption key using the unique pattern information, and may encrypt the program code using the generated encryption key.

In this case, the encryption unit 140 may encrypt the program code using an exclusive-OR combination of each bit value of the generated encryption key and the bit value of the program code.

If a plurality of pieces of unique data pattern information is generated by the generation unit 130, the encryption unit 140 may encrypt each of a plurality of data regions using the unique data pattern information of each of the plurality of segmented data regions.

Furthermore, the encryption unit 140 may encrypt the program code by taking into account at least one of the unique manufacturing information and unique chip information of the non-volatile memory in addition to the unique pattern information.

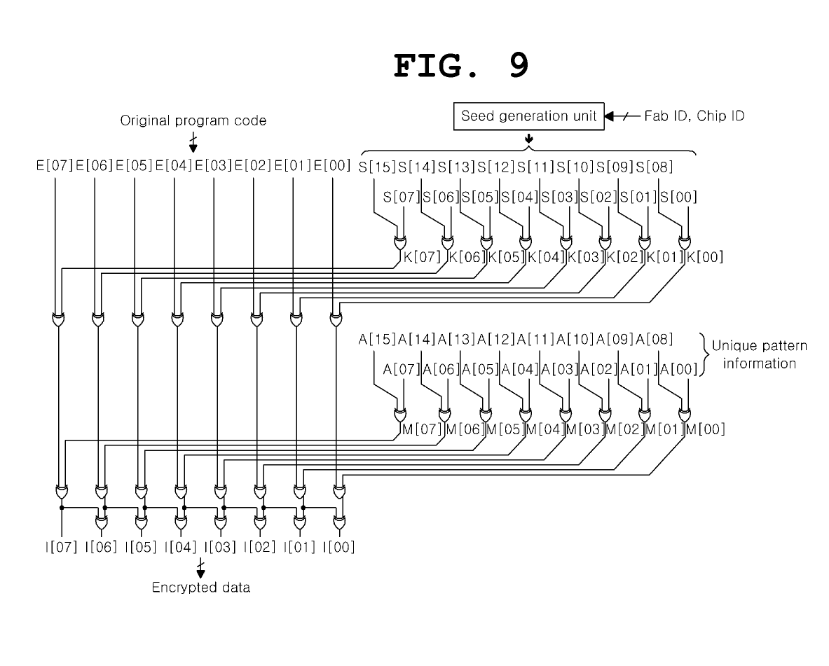

For example, as illustrated in FIG. 9, the encryption unit 140 receives the unique manufacturing information Fab ID and unique chip information Chip ID of non-volatile memory from a seed generation unit, generates a seed value S[15:0], outputs the value K[7:0] of an XOR combination between the bits of the generated seed value, converts the original data E[7:0][1] into encrypted data I[7:0] by performing an XOR combination between the data E[7:0][1] of the first 8 bits of the binary data of the original program code and the bits of the first output value K[7:0] and performing an XOR combination on the output value according to the execution of the XOR combination and a value M[7:0] output by an XOR combination between the bits of the unique pattern information A[15:0], and outputs the encrypted data I[7:0]. Such a process is repeatedly performed on all the data of the original program code, so that the binary data of the original program code may be converted into encrypted data. For example, assuming that the binary data of the original program code is 64 KB, the binary data of the original program code may be converted into the encrypted data by performing the processing process of FIG. 9 65536 times.

The seed generation unit illustrated in FIG. 9 may generate the 16-bit seed value S[15:0] using the unique manufacturing information Fab ID and the unique chip information Chip ID at one time, but is not limited thereto. The seed generation unit may generate the 8-bit seed value S[7:0] using the unique manufacturing information Fab ID, and may generate the 8-bit seed value S[15:8] using the unique chip information Chip ID.

As may be seen from FIG. 9, in the apparatus according to an embodiment of the present invention, although program code is the same, the program code encrypted and stored in non-volatile memory is different because at least one of the unique manufacturing information and unique chip information of the non-volatile memory is different. Accordingly, unique encryption results are obtained for the same program code. As a result, although program code encrypted and stored in non-volatile memory is repeatedly analyzed, it is difficult to obtain an encryption method and thus the program code can be prevented from leaking because the program code is encrypted by different encryption results.

Furthermore, the encryption unit 140 may encrypt the program code by further taking into account at least one of the user information and time or date information of the apparatus of the present invention in addition to the unique pattern information.

It will be apparent that the encryption unit 140 may encrypt the program code by taking into account all of the unique manufacturing information and unique chip information of the non-volatile memory, the user information, and the time or date information.

In this case, it will be apparent that the information that is used for the encryption unit 140 to encrypt the program code needs to be stored in a predetermined storage region so that the information is used for the decryption unit 180 to decrypt the program code.

The I/O control unit 150 stores the program code, encrypted by the encryption unit 140, in the non-volatile memory 160.

In this case, if the data of each of the plurality of data regions has been encrypted, the I/O control unit 150 may store the encrypted data of each of the plurality of data regions in a corresponding region of the non-volatile memory 160.

The decryption unit 180 is a means for decrypting the program code stored in the non-volatile memory 160, that is, the encrypted program code. The decryption unit 180 may receive the encrypted program code stored in the non-volatile memory 160 via the I/O control unit 150. The decryption unit 180 decrypts the program code stored in the non-volatile memory 160 using information used when the program code is stored, for example, the unique pattern information of the program code, the unique manufacturing information and unique chip information of the non-volatile memory, the user information, and the time or date information.

In this case, the decryption unit 180 may decrypt the program code stored in the non-volatile memory 160 using a decryption algorithm, corresponding to an encryption algorithm that has been used for the encryption unit 140 to encrypt the program code, and the unique pattern information of the program code stored in the pattern information storage unit 170. It will be apparent that if the encryption unit 140 has encrypted each of the plurality of data regions when encrypting the program code, the decryption unit 180 may decrypt the data of the program code for each of the data regions of the program code using the plurality of pieces of unique data pattern information stored in the pattern information storage unit 170.

The reading unit 190 reads the program code decrypted by the decryption unit 180.

As described above, the apparatus according to the present invention encrypts program code using the unique pattern information of the binary data of the program code, the unique manufacturing information and unique chip information of non-volatile memory, user information, and time or date information. Accordingly, although the same program code is encrypted in non-volatile memory, different program code is encrypted in each piece of non-volatile memory. Accordingly, the protection level of binary data stored in the non-volatile memory can be improved even without using complicated encryption hardware.

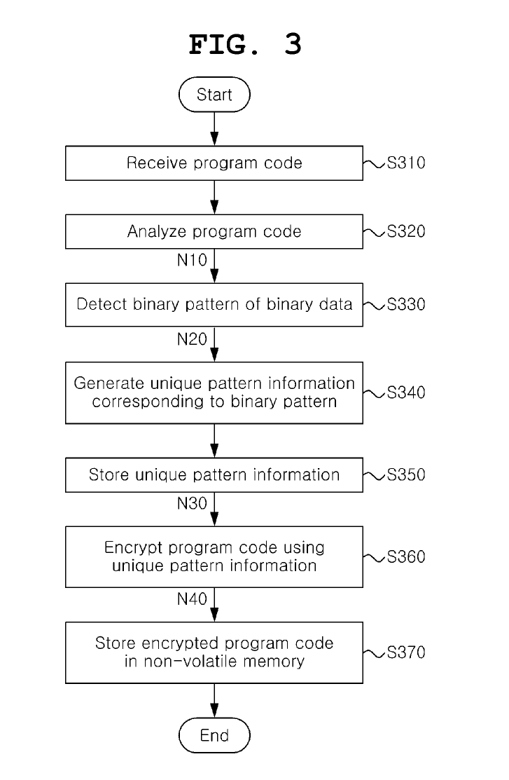

FIG. 3 illustrates an operation flowchart of a method of protecting binary data in non-volatile memory according to an embodiment of the present invention, and illustrates the flow of an operation in the apparatus illustrated in FIG. 1.

Referring to FIG. 3, in the method according to the present invention, program code to be stored in non-volatile memory is received, and the binary pattern of binary data included in the program code is detected by analyzing the received program code at steps S310 to S330.

In this case, at step S320, the program code may be analyzed using the bit values ‘0’ and ‘1’ of the binary data. At step S330, the binary pattern may be detected using the bit values of the binary data obtained by analyzing the program code, for example, the bit value ‘1’ or ‘0.’

When the binary pattern of the program code is detected at step S330, unique pattern information corresponding to the binary pattern is generated based on the detected binary pattern at step S340.

In this case, the unique pattern information may be m-bit information corresponding to the binary pattern. The unique pattern information may be generated or obtained via a function that uses a previously stored binary pattern and a data table for unique pattern information corresponding to the previously stored binary pattern or binary pattern information as a variable, or may be obtained via an algorithm for generating an encryption key.

The unique pattern information generated at step S340 is stored in a predetermined storage region. The program code is encrypted using the generated unique pattern information at steps S350 and S360.

It will be apparent that when the program code is encrypted using the unique pattern information, the encryption key may be generated using the unique pattern information, and the program code may be encrypted using the generated encryption key. The unique pattern information itself may be used as the encryption key depending on circumstances.

The program code encrypted based on the unique pattern information is stored in non-volatile memory at step S370.

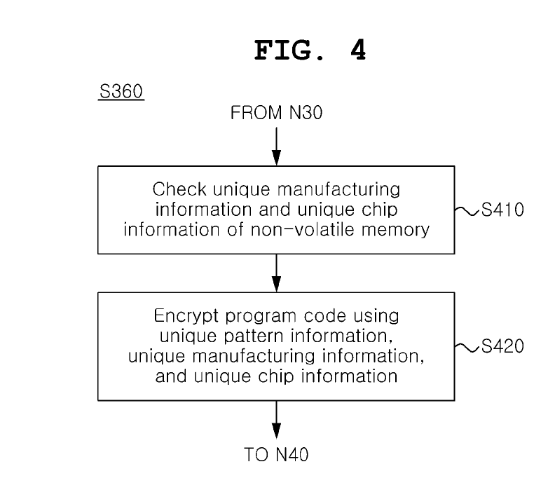

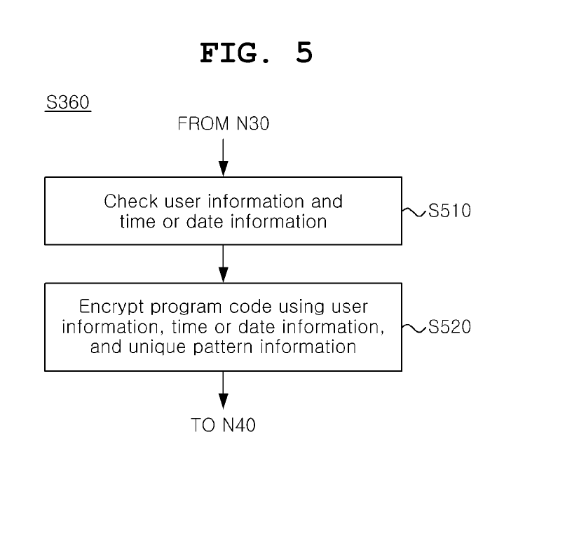

In the encryption of the program code at step S360, in order to generate program code differently encrypted for each piece of non-volatile memory, the program code may be encrypted using additional information in addition to the unique pattern information of the program code. This is described using FIGS. 4 and 5 as examples.

FIG. 4 illustrates an operation flowchart of step S360 of FIG. 3 according to an embodiment of the present invention.

Referring to FIG. 4, at step S360 of encrypting the program code, the unique manufacturing information and unique chip information of non-volatile memory in which the program code is to be stored are checked at step S410.

In this case, the unique manufacturing information of the non-volatile memory is the manufacturing number of the non-volatile memory, and may be a fabrication (FAB) ID. The unique chip information of the non-volatile memory may be the chip ID of the corresponding non-volatile memory. The unique manufacturing information and the unique chip information may be stored in a predetermined storage region, or may be encrypted and stored in a device so that they cannot be externally checked.

When the unique manufacturing information and unique chip information of the non-volatile memory are checked at step S410, the program code is encrypted using the unique manufacturing information and unique chip information of the non-volatile memory and the unique pattern information, generated at step S340, at step S420.

In the same manner, at step S420, an encryption key may be generated using the unique pattern information, the unique manufacturing information, and the unique chip information, and the program code may be encrypted using the generated encryption key.

FIG. 5 illustrates an operation flowchart of step S360 of FIG. 3 according to another embodiment of the present invention.

Referring to FIG. 5, in step S360 of encrypting the program code, the user information of a user who uses a corresponding device or who uses the program code stored in non-volatile memory and time or date information in the corresponding device are checked at step S510.

In this case, the user information may be stored in a predetermined storage region, or may be encrypted and stored in the device so that it cannot be externally checked. The time or date information may be obtained from the apparatus according to the present invention or from a device on which the apparatus according to the present invention is mounted.

When the user information and the time or date information are checked at step S510, the program code is encrypted using the user information, the time or date information, and the unique pattern information, generated at step S340, at step S520.

In the same manner, at step S520, an encryption key may be generated using the unique pattern information, the user information, and the time or date information, and the program code may be encrypted using the generated encryption key.

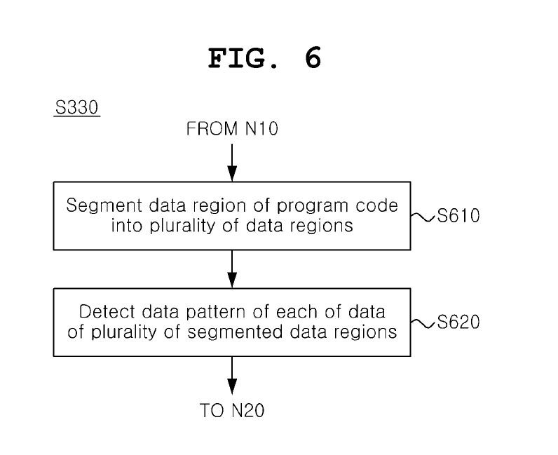

FIG. 6 illustrates an operation flowchart of step S330 of FIG. 3 according to an embodiment of the present invention.

Referring to FIG. 6, in step S330 of detecting the binary pattern, the data region of the binary data of the program code is segmented into a plurality of data regions at step S610.

In this case, at step S610, the binary data may be divided and assigned into a predetermined number of data regions, or the binary data of the program code may be divided and assigned on a predetermined region basis.

When the data region of the binary data is segmented into the plurality of data regions at step S610, the data pattern of each of the data of the plurality of segmented data regions is detected at step S620.

Furthermore, in the method according to the present invention, when the data pattern of each of the plurality of data regions is detected at step S620, the binary pattern of the program code may be detected using the plurality of detected data patterns. That is, the binary pattern may be detected using a combination of the plurality of data patterns or a table for the plurality of data patterns.

Furthermore, at step S620, the program code of FIG. 3 may be encrypted directly using the plurality of detected data patterns. That is, when the plurality of data patterns is detected at step S620, the unique data pattern information of each of the data of the plurality of data regions is generated based on the plurality of detected data patterns. The data of each of the plurality of regions of the program code is encrypted using a plurality of pieces of unique data pattern information.

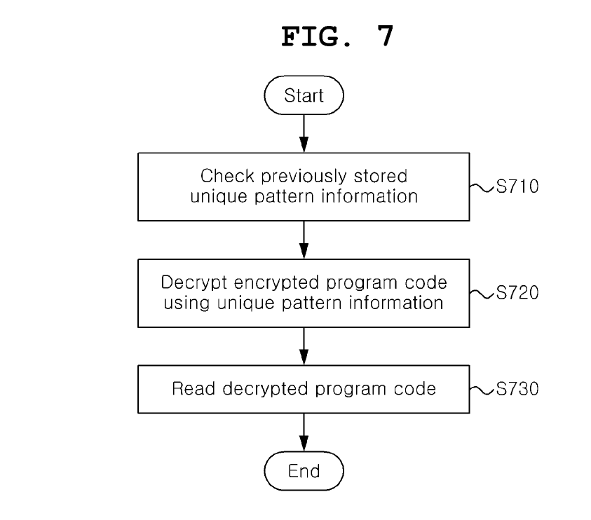

FIG. 7 illustrates an operation flowchart of a method of reading the stored program code of FIG. 3 according to an embodiment of the present invention.

Referring to FIG. 7, in order to read program code stored in non-volatile memory, the unique pattern information of the program code stored in a predetermined storage region is checked. Encrypted program code stored in the non-volatile memory is decrypted using the checked unique pattern information at steps S710 and S720.

It will be apparent that when the encrypted program code is decrypted at step S720 if the program code has been encrypted using one or more of the unique manufacturing information, unique chip information, user information and time or date information of the non-volatile memory in addition to the unique pattern information, the encrypted program code is decrypted using one or more of the unique pattern information, used to encrypt the program code, and the unique manufacturing information, unique chip information, user information and time or date information of the non-volatile memory.

When the program code stored in the non-volatile memory is decrypted, the decrypted program code is read at step S730.

The method of protecting binary data in non-volatile memory according to an embodiment of the present invention may be implemented in the form of program instructions that can be executed by a variety of computer means, and may be stored in a computer-readable storage medium. The computer-readable storage medium may include program instructions, a data file, and a data structure solely or in combination. The program instructions that are stored in the medium may be designed and constructed particularly for the present invention, or may be known and available to those skilled in the field of computer software. Examples of the computer-readable storage medium include magnetic media such as a hard disk, a floppy disk and a magnetic tape, optical media such as CD-ROM and a DVD, magneto-optical media such as a floptical disk, and hardware devices particularly configured to store and execute program instructions such as ROM, RAM, and flash memory. Examples of the program instructions include not only machine language code that is constructed by a compiler but also high-level language code that can be executed by a computer using an interpreter or the like. The above-described hardware components may be configured to act as one or more software modules that perform the operation of the present invention, and vice versa.

As described above, although the present invention has been described above in conjunction with specific details, such as specific elements, and limited embodiments and drawings, these are provided merely to help the overall understanding of the present invention. The present invention is not limited to these embodiments, and various modifications and variations can be made based on the foregoing description by those having ordinary knowledge in the art to which the present invention pertains.

Accordingly, the technical spirit of the present invention should not be defined based on only the described embodiments, and the following claims, all equivalents to the claims and equivalent modifications should be construed as falling within the scope of the spirit of the present invention.

What is claimed is:

1. A method of protecting binary data in non-volatile memory, comprising:
receiving, at a processor, program code;
detecting, by the processor, a binary pattern of binary data constituting the program code by analyzing the received program code;
generating, by the processor, unique pattern information corresponding to the binary pattern based on the detected binary pattern;
encrypting, by the processor, the program code using the generated unique pattern information; and
storing, by the processor, the encrypted program code in memory.

2. The method of claim 1, wherein the encrypting comprises encrypting, by the processor, the program code by further taking into account at least one of unique manufacturing information and unique chip information of the memory.

3. The method, by the processor, of claim 1, wherein the encrypting comprises encrypting the program code by further taking into account at least one of user information and time or date information.

4. The method of claim 1, further comprising:
decrypting, by the processor, the encrypted program code stored in the memory using the unique pattern information; and
reading, by the processor, the decrypted program code.

5. The method of claim 4, further comprising storing, by the processor, the generated unique pattern information in a predetermined storage region,
wherein the decrypting comprises decrypting, by the processor, the encrypted program code using the stored unique pattern information.

6. The method of claim 1, further comprising segmenting, by the processor, a data region of the received program code into a plurality of regions,
wherein the detecting comprises detecting, by the processor, a data pattern of data of each of the plurality of segmented regions,
wherein the generating comprises generating, by the processor, unique data pattern information of the data of each of the plurality of regions based on the detected data pattern, and
wherein the encrypting comprises encrypting, by the processor, the data of each of the plurality of regions using the generated unique data pattern information.

7. The method of claim 1, further comprising segmenting, by the processor, a data region of the received program code into a plurality of regions,
wherein the detecting comprises detecting, by the processor, a data pattern of data of each of the plurality of segmented regions and detecting the binary pattern using the detected data patterns.

8. A non-transitory computer-readable storage medium having stored therein computer program instructions, which when executed by a processor, causes the processor to:
receive program code;
detect a binary pattern of binary data constituting the program code by analyzing the received program code;
generate unique pattern information corresponding to the binary pattern based on the detected binary pattern;
encrypt the program code using the generated unique pattern information as a key value; and
store the encrypted program code in memory.

9. An apparatus for protecting binary data in non-volatile memory, comprising a processor configured to:
receive program code;
detect a binary pattern of binary data constituting the program code by analyzing the received program code;
generate unique pattern information corresponding to the binary pattern based on the detected binary pattern;
encrypt the program code using the generated unique pattern information as a key value; and
store the encrypted program code in memory.

10. The apparatus of claim 9, wherein the processor is further configured to encrypt the program code by further taking into account at least one of unique manufacturing information and unique chip information of the memory.

11. The apparatus of claim 9, wherein the processor is further configured to encrypt the program code by further taking into account at least one of user information and time or date information.

12. The apparatus of claim 9, wherein the processor is further configured to:
decrypt the encrypted program code stored in the memory using the unique pattern information; and
read the decrypted program code.

13. The apparatus of claim 12, wherein the processor is further configured to:
store the generated unique pattern information in a predetermined storage region,
decrypt the encrypted program code using the unique pattern information stored in the predetermined storage region.

14. The apparatus of claim 9, wherein the processor is further configured to:
segment a data region of the received program code into a plurality of regions;
detect a data pattern of data of each of the plurality of segmented regions;
generate unique data pattern information of the data of each of the plurality of regions based on the detected data pattern; and
encrypt the data of each of the plurality of regions using the generated unique data pattern information.

15. The apparatus of claim 9, wherein the processor is further configured to:
segment a data region of the received program code into a plurality of regions;
detect a data pattern of data of each of the plurality of segmented regions; and
detect the binary pattern using the detected data patterns.
